(19) United States
(12) Patent Application Publication
(10) Pub. No.: US 2009/0320541 A1
(43) Pub. Date: Dec. 31, 2009

(54) BOLT SEAL

(75) Inventor: Robert E. Stone, Upland, IN (US)

Correspondence Address: BAKER & DANIELS LLP, 202 South Michigan Street, Suite 1400, South Bend, IN, 46601, US

(73) Assignee: E. J. Brooks Company, Livingston, NJ (US)

(21) Appl. No.: 12/358,312

(22) Filed: Jan. 23, 2009

Related U.S. Application Data
(63) Continuation-in-part of application No. 12/212,687, filed on Sep. 18, 2008.
(60) Provisional application No. 61/141,412, filed on Dec. 30, 2008.
(60) Provisional application No. 61/133,520, filed on Jun. 30, 2008.

(51) Int. Cl. E05B 39/02

(52) U.S. Cl. 70/440

(57) ABSTRACT

A sealing device is provided that includes a bolt having a shaft, a tapered end and a circumferential groove; a lock body having an open end leading into a hollow portion; an overmold substantially surrounding the lock body and including an aperture aligned with the open end of the lock body; a lock clip located in the hollow portion of the lock body; and a washer having a hole aligned with the aperture in the overmold and the opening in the lock body and located between an end of the overmold and the lock clip, the lock clip including a plurality of spokes extending inwardly from an outer periphery portion. Some of the spokes can include an inner flange extending generally perpendicular to the spoke, and the inner flanges form a non-continuous inner ring portion.

### BACKGROUND OF THE INVENTION

This Continuation-In-Part application claims the benefit of U.S. Provisional Patent Application Ser. No. 61/141,412 filed Dec. 30, 2008, U.S. patent application Ser. No. 12/212,687 filed Sep. 18, 2008, and U.S. Provisional Patent Application Ser. No. 61/133,520 filed Jun. 30, 2008, the complete disclosures of which are hereby expressly incorporated by reference.

The subject invention relates to security devices, and in particular, to security seals that incorporate a bolt and lock body.

It is well known to use security seals in the shipping industry to provide tamper resistant and tamper indicating closures for a variety of shipping containers and receptacles. For example, it is common to place one or more security seals on the exterior of the shipping container through a hasp or other hardware after the contents of the container have been verified.

For numerous reasons a shipper would be required to seal a container after the contents had been placed therein. For example, in international shipping, customs may require that the freight container be sealed. In addition, in domestic shipping, it is often desirable to seal the freight container to prevent tampering or theft of the contents.

As such, it is desirable to have a security seal that both discourages and prevents unauthorized opening of the container and further provides an indication if the container has been opened during transportation. Accordingly, if a seal is broken, it will enable the recipient to readily determine that the container has been opened and may take appropriate action, such as rejecting the shipment or evaluating what is missing or tampered with.

There are varieties of different types of container seals, and some incorporate cables or plastic ties that cannot be removed once locked without breaking the seal or cutting the cable or tie. Other seals incorporate a bolt and are often known as a bolt seal. One example of a bolt seal is disclosed in U.S. Patent Application Publication No. 2007/0007776 A1 to Beard et al. The bolt seal in Beard et al. utilizes a bolt having a shaft and an enlarged head at one end and a tapered end at the other end. It is common for such bolts to include a circumferential groove adjacent the tapered end. The bolt seal also includes a cover surrounding a locking body. The locking body includes a stepped pair of grooves, and a locking ring is located in the grooves and configured to lock with the groove adjacent the tapered end of the bolt.

Another locking seal device is disclosed in U.S. Pat. No. 4,690,443 to Brammall. The device in Brammall includes a bolt having a U-shaped shaft and an enlarged head on one end, a tapered end on the opposite end, and a circumferential groove adjacent the tapered end. The device also includes a lock body having a body member with an annular recess therein and a retainer having a hole therethrough and fixed to the body to overlie the recess. A pair of locking jaws are supported above the bottom of the recess and are biased together. In one aspect, the recess is tiered to define a shoulder upon which the locking jaws rest, and an elastic O-ring extends around the locking jaws to bias them together.

Another sealing device is disclosed in U.S. Pat. No. 7,226,095 B2 to Huang. As with the devices discussed above, the sealing device in Huang also includes a bolt having a shaft and an enlarged head at one end, and the other end is tapered with a circumferential groove located adjacent the tapered end. The sealing device further includes a cylindrical metal barrel and an overmolded plastic sleeve surrounding the barrel. The device also includes a metal disk at the bottom of the overmolded plastic sleeve and a wire clip designed to spring and lock into the circumferential groove of the bolt when the bolt is inserted in the barrel to prevent the bolt from being subsequently withdrawn therefrom.

Other examples of bolt seals are found in U.S. Pat. No. 3,975,040 to Van Gompel; U.S. Pat. No. 4,626,009 to Burnett et al.; and U.S. Pat. No. 4,936,612 to Kohn.

It is an object of the subject invention to provide an improved bolt seal including a unique combination of a lock ring or clip, washer, lock body, and overmold.

### SUMMARY OF THE INVENTION

In one embodiment of the invention, a sealing device is provided that includes a bolt having a shaft, a tapered end and a circumferential groove; a lock body having an open end leading into a bore; an overmold substantially surrounding the lock body and including an aperture aligned with the open end of the lock body; a lock ring located in the bore of the lock body; and a washer having a hole aligned with the aperture in the overmold and the opening in the lock body and located between the overmold and the lock ring.

The lock ring may include a plurality of spokes extending inwardly from an outer ring portion with at least some of the spokes including an inner flange extending generally perpendicular to the spokes so that the inner flanges form a non-continuous inner ring portion.

The lock body may have a generally cylindrical configuration including a closed end opposite the opening with a plurality of axially extending ridges formed along an inner surface of the bore. The lock body may also include radially extending ridges on an inner surface of the closed end. Some of the axially extending ridges and radially extending ridges may intersect at a bottom of the bore and may include a central hub-like ridge from which the radially extending ridges extend. The hub-like ridge may include a central opening. The lock body may also have a counterbore above the axially extending ridges, and there may be twice as many axially extending ridges as radially extending ridges.

The overmold may have a hollow interior and partially closed ends. The overmold may also have a central opening at one end and a plurality of external cavities surrounding the central opening, and the other end of the overmold may have a tapered central hole extending into the interior. The lock body can also include scallops in a side wall surrounding the open end. The lock body can also include an annular lip extending around the counterbore. The lock ring can be located at the top of the axially extending ridges, and the washer is located over the lock ring in the counterbore.

In another embodiment of the invention, a sealing device is provided that includes a bolt having a shaft, a tapered end and a circumferential groove; a generally rectangular lock body having an open end leading into a hollow portion; an overmold substantially surrounding the lock body and including an aperture aligned with the open end of the lock body; a lock clip located in the hollow portion of the lock body; and a washer having a hole aligned with the aperture in the overmold and the open end in the lock body and located between an end of the overmold and the lock clip.

The lock clip may have a generally square configuration and include a plurality of spokes extending inwardly from corners of an outer periphery portion. At least some of the spokes can include an inner flange extending generally perpendicular to the spokes. The inner flanges can form a non-continuous inner ring portion.

The overmold can have a generally rectangular configuration including a square opening in the end opposite the end with the aperture, and the lock body can include a plurality of axially extending ridges projecting from an inner surface in the hollow portion. The lock body may include radially extending ridges on an inner surface of the end opposite the open end, and at least some of the axially extending ridges and some of the radially extending ridges may intersect. Some of the axially extending ridges may extend along a central portion of side walls of the lock body and other axially extending ridges may extend along corners where the side walls intersect. The lock body may include a central hub-like ridge wherein the radially extending ridges project, and the hub-like ridge may include a central opening.

The overmold can have a hollow interior and partially closed ends, and one of the partially enclosed ends may have a plurality of external cavities surrounding the aperture. The other end of the overmold may have a tapered square opening aligned with a square cavity in the lock body. The lock clip can be located at the top of the axially extending ridges, the washer can be located over the lock clip in the lock body, and the washer can be located between the end of the overmold having the aperture and the lock clip.

In yet another embodiment of the invention, a sealing device is provided that includes a bolt having a shaft, a tapered end and a circumferential groove; a lock body having an open end leading into a hollow portion and an opposite end having a generally square cavity therein; an overmold substantially surrounding the lock body and including an aperture in one end that is aligned with the open end of the lock body and a generally square opening in the other end aligned with the cavity in the lock body; a lock clip located in the bore of the lock body and engaging the circumferential groove and the bolt; and a washer having a hole aligned with the aperture in the overmold and the open end in the lock body and located between the end of the overmold having the aperture and the lock ring.

Each of the ends of the overmold may include cavities, a central hub, and spokes extending from the central hub between the cavities. The lock body and overmold can have a generally rectangular configuration with a generally square cross section and the lock clip and said washer can have a generally square planar configuration.

The lock body may include axially extending ridges along internal surfaces thereof and radially extending ridges on the end having the square cavity. The lock body can have side walls that form a generally rectangular configuration and some of the axially extending ridges are located in a central portion of each of the side walls and others of the axially extending ridges are located in corners of the lock body formed by intersecting side walls.

In a further embodiment of the invention, a sealing device is provided that includes a bolt having a shaft, a tapered end and a circumferential groove; a lock body having an open end leading into a hollow portion; an overmold substantially surrounding the lock body and including an aperture aligned with the open end of the lock body and an opposite end having an opening, each of the ends including cavities surrounding a central hub wherein the respective aperture and opening are located; and a lock clip located in the hollow portion of the lock body.

The lock body and the overmold can have generally rectangular configurations and the lock clip can have a generally square planar configuration. The seal device may further include a washer having a hole aligned with the aperture in the overmold and the open end in the lock body, and the washer may also have a generally square planar configuration.

### BRIEF DESCRIPTION OF THE DRAWINGS

The above-mentioned and other features and objects of this invention and the manner of obtaining them will become more apparent and the invention itself will be better understood by reference to the following description of embodiments of the present invention taken in conjunction with the accompanying drawings, wherein:

FIG. 1 is a perspective view of a sealing device in accordance with one embodiment of the invention;

FIG. 2 is a side view of the sealing device of FIG. 1;

FIG. 3 is a cross sectional view of the sealing device of FIG. 1 taken along line 3-3 of FIG. 2;

FIG. 4 is a perspective view of one embodiment of a bolt for use with the sealing device of FIG. 1;

FIG. 5 is an enlarged view of the area of the bolt indicated as 5 in FIG. 4;

FIG. 6 is an enlarged view of the area of the bolt indicated as 6 in FIG. 4;

FIG. 7 is an end view of the bolt of FIG. 4;

FIG. 8 is an enlarged view of a portion of a circumferential groove indicated as 8 in FIG. 5;

FIG. 9 is a perspective view of one embodiment of a lock body assembly of the sealing device of FIG. 1;

FIG. 10 is an end view of the lock body assembly of FIG. 9;

FIG. 11 is a cross sectional view of the lock body assembly taken along line 11-11 of FIG. 10;

FIG. 12 is a perspective view of one embodiment of a lock body for use with the assembly of FIG. 9;

FIG. 13 is a plan view of the lock body of FIG. 12;

FIG. 14 is a perspective cross sectional view of the lock body taken along line 14-14 of FIG. 13;

FIG. 15 is a cross sectional view of the lock body taken along line 15-15 of FIG. 13;

FIG. 16 is a cross sectional view of the lock body taken along line 16-16 of FIG. 13;

FIG. 17 is an enlarged view of a portion of the lock body indicated as 17 in FIG. 13;

FIG. 18 is an enlarged view of a portion of the lock body indicated as 18 in FIG. 13;

FIG. 19 is an enlarged view of a portion of the lock body indicated as 19 in FIG. 16;

FIG. 20 is an enlarged view of a portion of the lock body indicated as 20 in FIG. 15;

FIG. 21 is a perspective view of one embodiment of an overmold for use with the lock body assembly of FIG. 9;

FIG. 22 is an end view of the overmold of FIG. 21;

FIG. 23 is a cross sectional view of the overmold taken along line 23-23 of FIG. 22;

FIG. 24 is a cross sectional view of the overmold taken along line 24-24 of FIG. 22;

FIG. 25 is an end view of the overmold from the opposite end shown in FIG. 22;

FIG. 26 is a perspective view of one embodiment of a lock ring for use with the lock body assembly of FIG. 9;

FIG. 27 is a plan view of the lock ring of FIG. 26;

FIG. 28 is a side view of the lock ring of FIG. 26;

FIG. 29 is a plan view of one embodiment of a washer for use with the lock body assembly of FIG. 9; and

FIG. 30 is a side view of the washer of FIG. 29.

FIG. 31 is a perspective view of an alternate embodiment sealing device in accordance with the subject invention;

FIG. 32 is a bottom perspective exploded view of the sealing device of FIG. 31;

FIG. 33 is a top perspective exploded view of the sealing device of FIG. 31;

FIG. 34 is a top plan view of the sealing device of FIG. 31;

FIG. 35 is a cross sectional view of the sealing device of FIG. 31 taken along line 35-35 in FIG. 34;

FIG. 36 is a top plan view of a lock body assembly of the sealing device of FIG. 31 with the bolt removed;

FIG. 37 is a cross sectional view of the lock body assembly of FIG. 36 taken along line 37-37 in FIG. 36;

FIG. 38 is a plan view of a lock body of the seal device of FIG. 31;

FIG. 39 is a cross sectional view of the lock body of FIG. 38 taken along line 39-39;

FIG. 40 is another cross sectional view of the lock body of FIG. 38 taken along line 40-40;

FIG. 41 is an enlarged view of a portion of the lock body of the area indicated in FIG. 38;

FIG. 42 is a bottom plan view of the lock body of FIG. 38;

FIG. 43 is a perspective view of an overmold for the lock body assembly of FIG. 36;

FIG. 44 is a top plan view of the overmold of FIG. 43;

FIG. 45 is a cross sectional view of the overmold of FIG. 43 taken along line 45-45 in FIG. 44;

FIG. 46 is another cross sectional view of the overmold of FIG. 43 taken along line 46-46 in FIG. 44;

FIG. 47 is an enlarged view of a portion of the overmold of FIG. 43 of the area indicated in FIG. 44;

FIG. 48 is a bottom plan view of the overmold of FIG. 43;

FIG. 49 is an enlarged view of a portion of the area of the overmold of FIG. 43 of the area indicated in FIG. 48;

FIG. 50 is a plan view of a locking clip for the seal device of FIG. 31;

FIG. 51 is a side view of the locking clip of FIG. 50;

FIG. 52 is a plan view of a washer for use within the sealing device of FIG. 31; and

FIG. 53 is a side view of the washer of FIG. 52.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

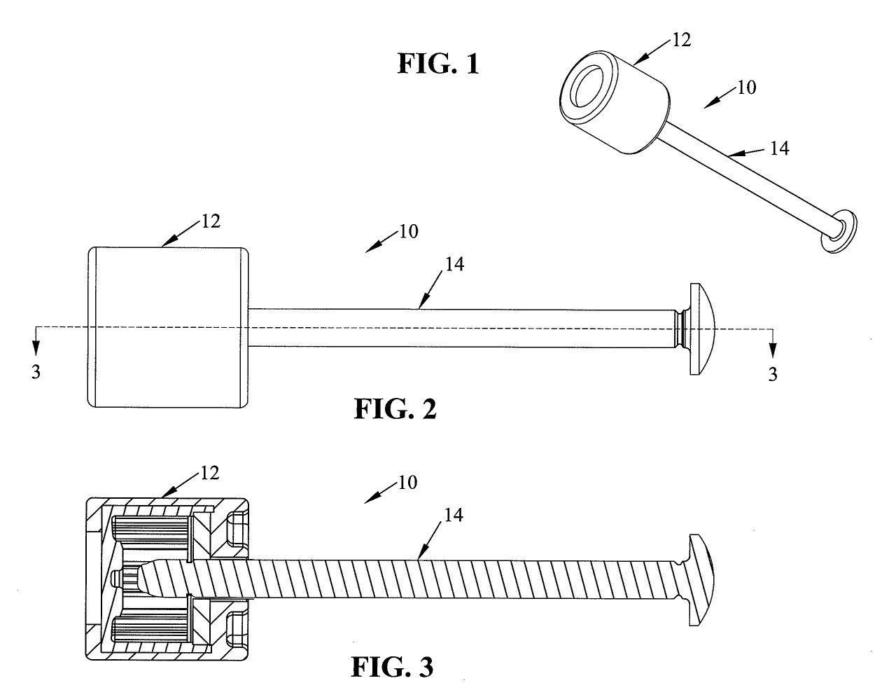

Referring now to FIGS. 1-3, one embodiment of a sealing device in accordance with the subject invention is generally indicated as 10. Sealing device 10 includes a lock body assembly, generally indicated as 12, and a locking bolt, generally indicated as 14.

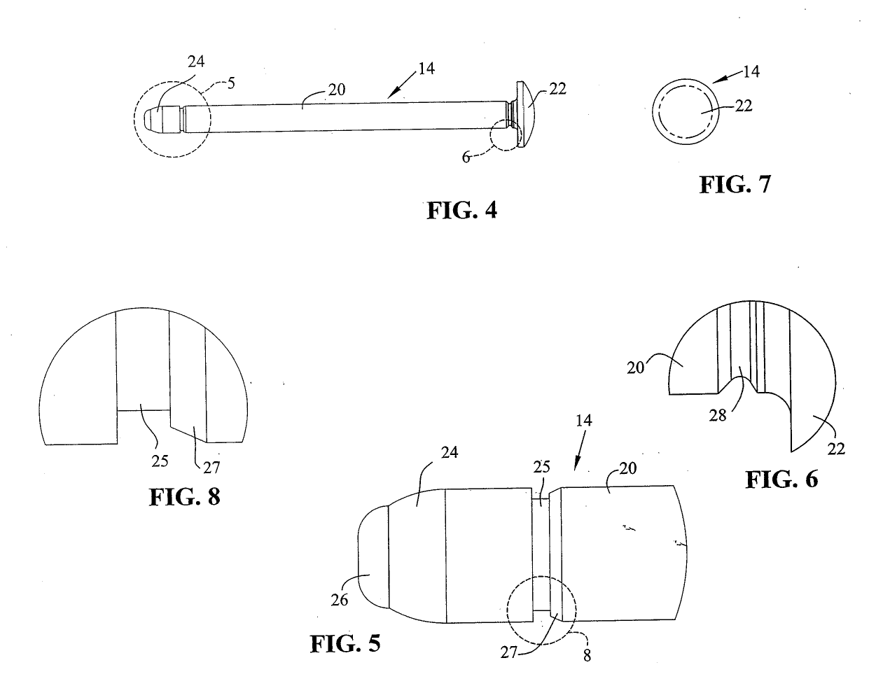

Now referring to FIGS. 4-8, the details of bolt 12 are shown in greater detail. Bolt 12 includes a shaft 20, an enlarged head 22 at one end thereof, and a tapered end 24 at the other end. Bolt 12 also includes a circumferential groove 25 located adjacent tapered end 24 (as best shown in FIG. 5), and a somewhat rounded nose 26 at the tip of end 24. Please note that tapered end 24 may include a slight convexity, as best shown in FIG. 5. In addition, note that one wall of groove 25 may include a tapered end or chamfer transition 27 to shaft 20. Bolt 12 also includes a circumferential groove 28 adjacent enlarged head 22, as best shown in FIG. 6. Bolt 12 may be manufactured from a hardened steel, such as 1038, or other suitable material.

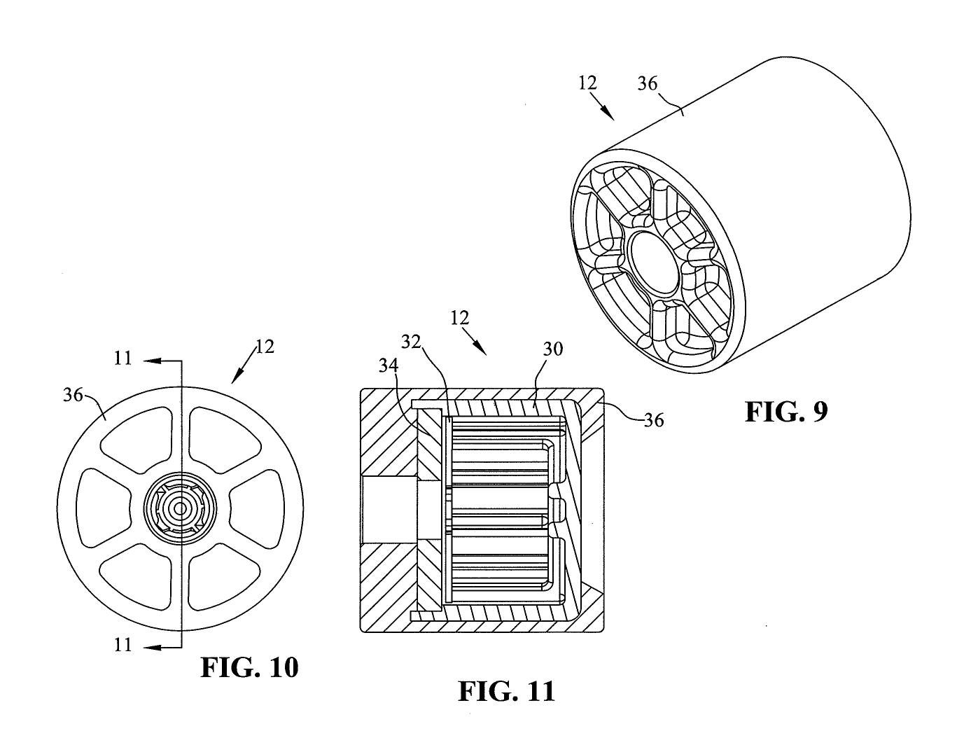

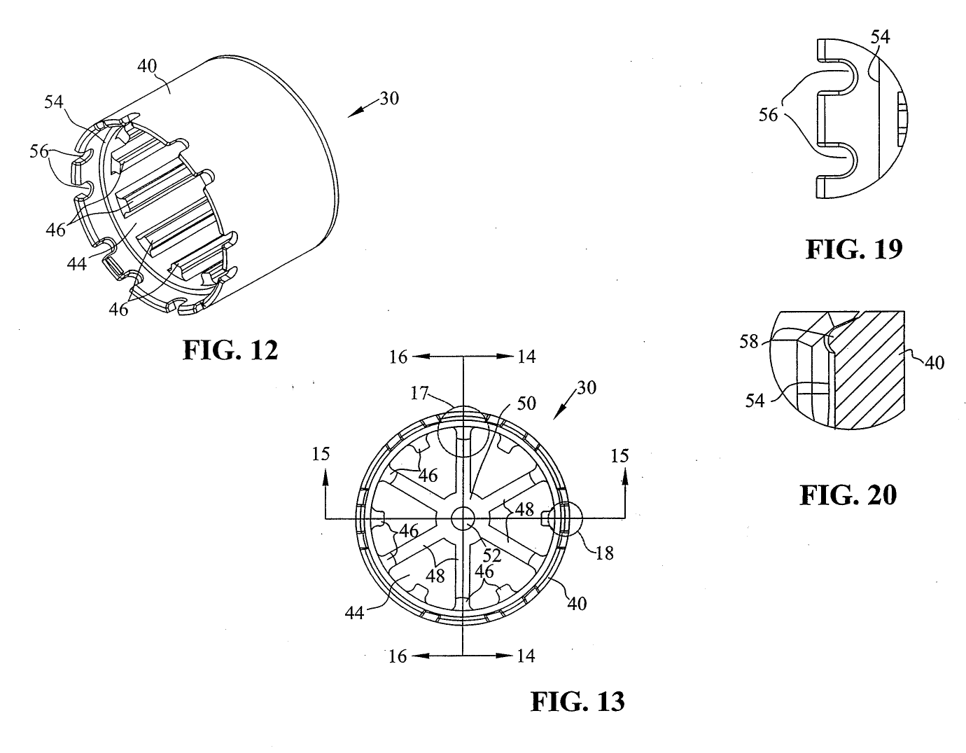

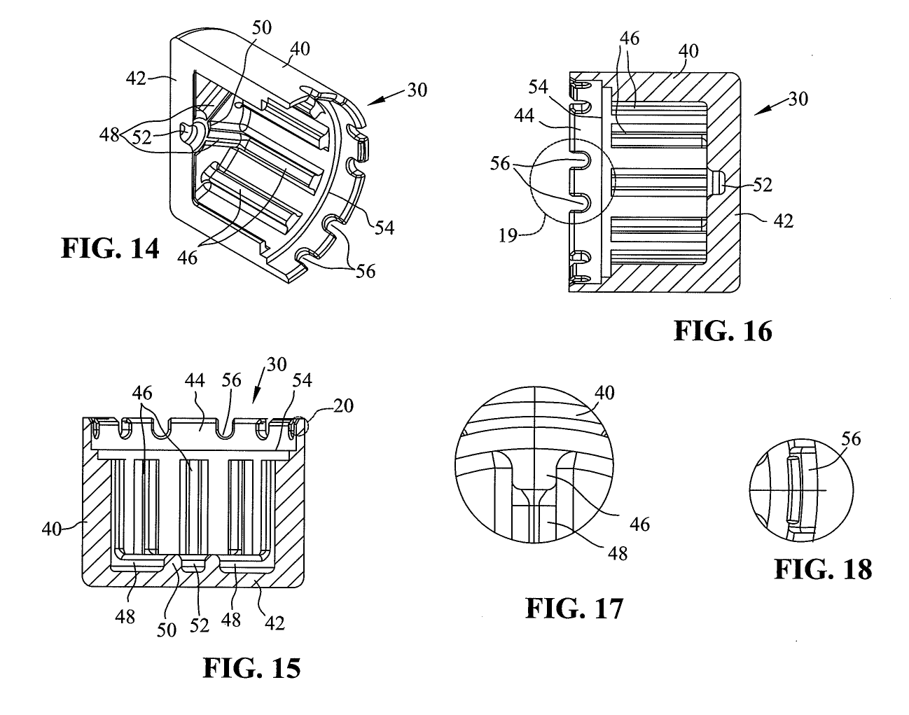

Details of lock body assembly 12 are shown in FIGS. 9-11. Lock body assembly 12 includes a lock body 30, a lock ring or clip 32, a washer 34, and an overmold 36. Referring now to FIGS. 12-20, details of lock body 30 are shown. Lock body 30 may be injection molded from an ABS plastics or other known suitable materials/or methods of manufacture can be used. Lock body 30 has a generally hollow cylindrical configuration and includes a side wall 40, a bottom wall 42 at one end of the side wall, and an open end 44 at the opposite end. The lock body also includes a plurality of equally spaced axially extending ridges 46 projecting from an inner surface of side wall 40. In addition, lock body 30 includes a plurality of equally spaced radially extending ridges 48 on an inner surface of bottom wall 42. Ridges 48 extend from or intersect a central hub-like ridge 50 on bottom wall 42, and a central opening 52 is located in hub-like ridge 50. In the embodiment shown, there are twice as many axially extending ridges 46 as radially extending ridges 48, and ridges 48 intersect corresponding ridges 46 at the bottom of side wall 40, as best shown in FIGS. 14 and 15.

Lock body 30 also includes a counterbore 54 in side wall 40 adjacent opening 44, and further includes scallops or slots 56 at the top end of side wall 40. Also, lock body 30 includes an annular locking lip 58 extending around the upper end of side wall 40 and counterbore 54 (as best shown in FIG. 20) for retaining lock ring 32 and washer 34 in lock body 30 as discussed below.

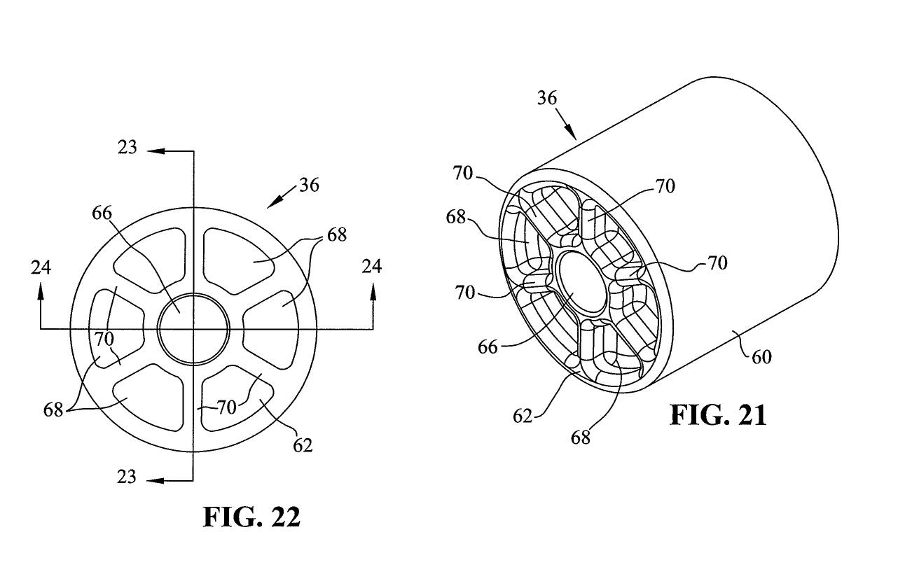

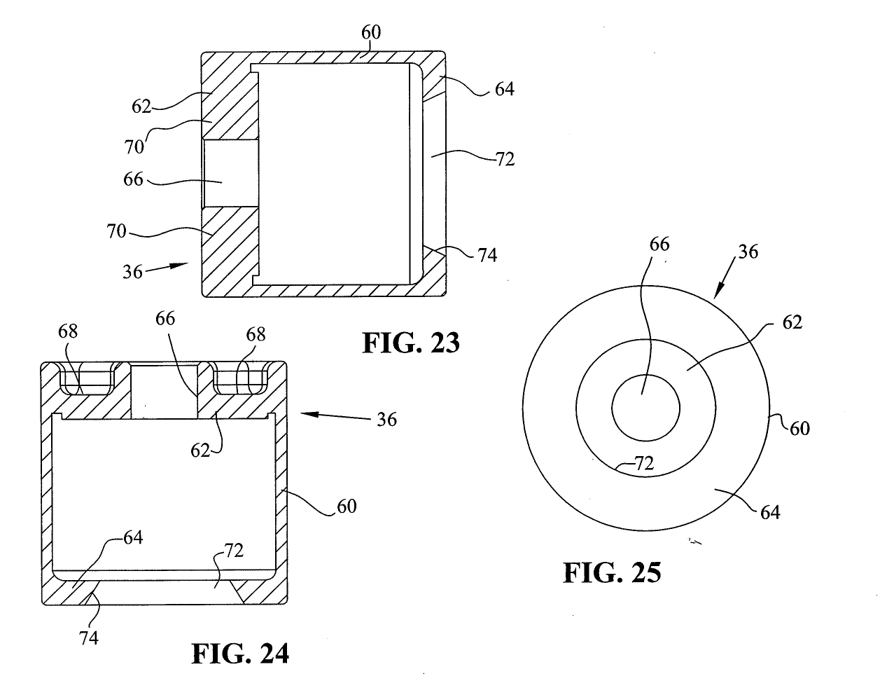

Referring now to FIGS. 21-25, details of overmold 36 are shown. Overmold 36 may be molded from a polypropylene or made using other known suitable materials or methods. Overmold 36 has a generally hollow cylindrical configuration and includes a side wall 60, one partially enclosing end wall 62, and another partially enclosing end wall 64. End wall 62 includes a central opening 66 and a plurality of external cavities 68 surrounding central opening 66. A plurality of spokes 70 extend between cavities 68. End wall 64 includes a central opening 72, which may include an annular taper or chamfer 74.

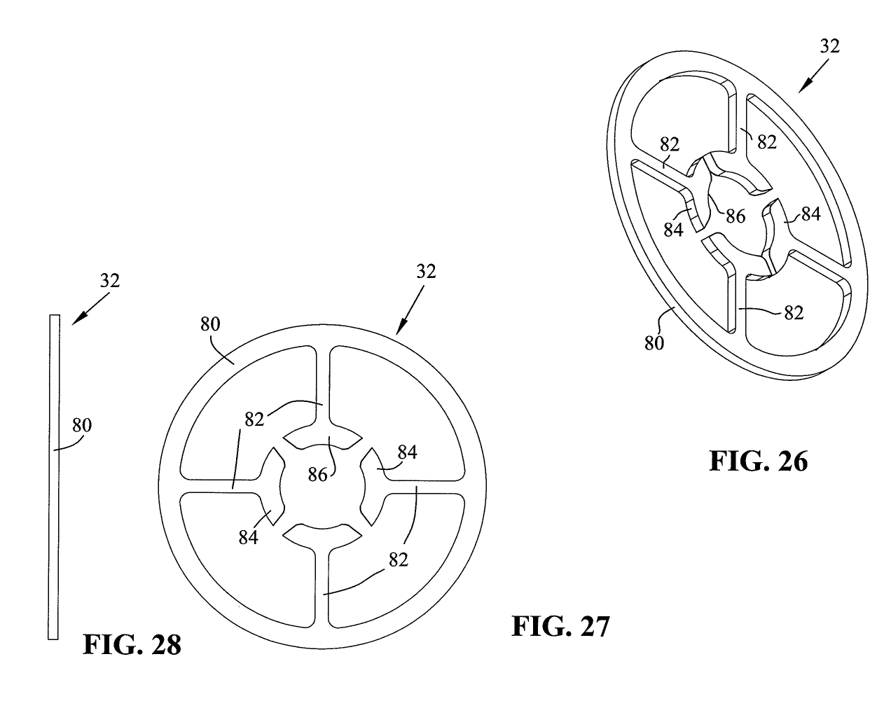

Details of lock ring 32 are shown in FIGS. 26-28. Lock ring 32 can be made from a stamped, high tensile banding or manufactured using other known suitable materials or methods. Lock ring 32 includes an outer ring-like portion 80 and a plurality of spokes 82 extending inwardly from ring-like portion 80. Lock ring 32 also includes inner flanges 84 extending generally perpendicular to spokes 82. Flanges 84 form a non-continuous inner ring portion 86.

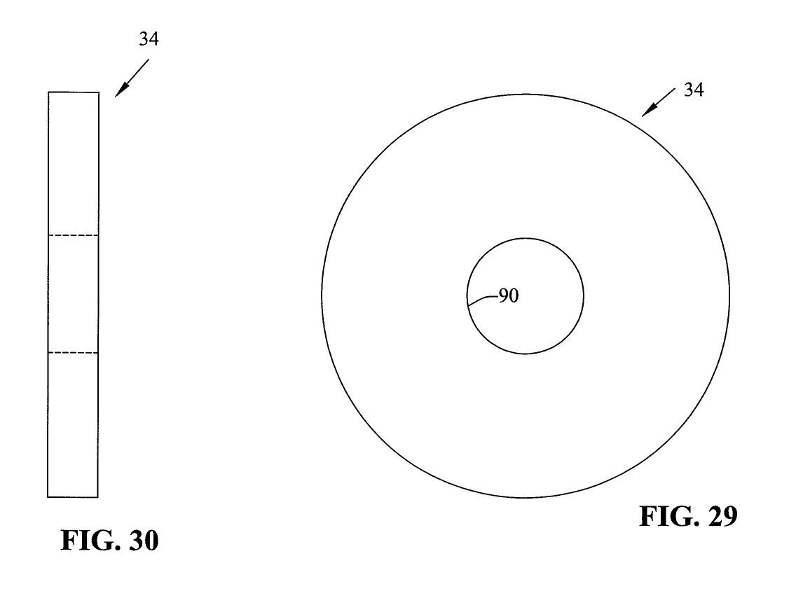

Now referring to FIGS. 29-30, enlarged views of washer 34 are shown. Washer 34 has a generally flat disc-shaped configuration and includes a central hole 90. Washer 34 can be stamped from a cold rolled steel or made using other suitable materials or methods.

To assemble the lock body assembly 12, lock ring 32 is placed in the open end 44 of lock body 30 and bearing upon the end of axially extending ridges 46. Then, washer 34 is placed in counterbore 54 over lock ring 32 and is held in place by locking lip 58. After the lock ring 32 and washer 34 are in place, overmold 36 can be molded around or otherwise fixed around lock body 30.

In operation, the tapered end 24 of bolt 14 is inserted through opening 66 in overmold 36 through opening 90 of washer 34 and inside non-continuous inner ring portion 86 of lock ring 32. The non-continuous ring portion 86 of lock ring 32 is can flex allowing shaft 20 of bolt 14 to enter into and expand the inner ring portion opening; however, when circumferential groove 25 encounters ring-like portion 86, the tensile stress in the lock ring will cause the inner ring portion 86 to snap into the circumferential groove 25. The right angle wall adjacent circumferential groove 25 towards the tapered end will thereby prevent bolt 14 from being removed or otherwise pulled out of lock body assembly 12. As such, the only way to remove bolt 14 is to cut the bolt or destroy lock body assembly 12, thereby providing evidence of tampering.

It should also be appreciated that the cavities 68 around overmold 36 can be used to provide a grip on the lock body assembly. One use thereof can be to prevent the lock body from rotating. It should further be appreciated that the cavities and spokes in the overmold as well as the axial and vertical ridges in the lock body provide a unique configuration providing both weight reduction and strength/rigidity.

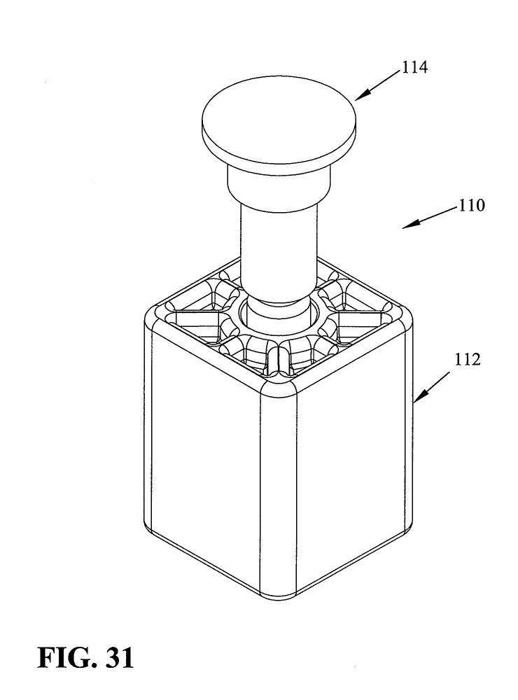

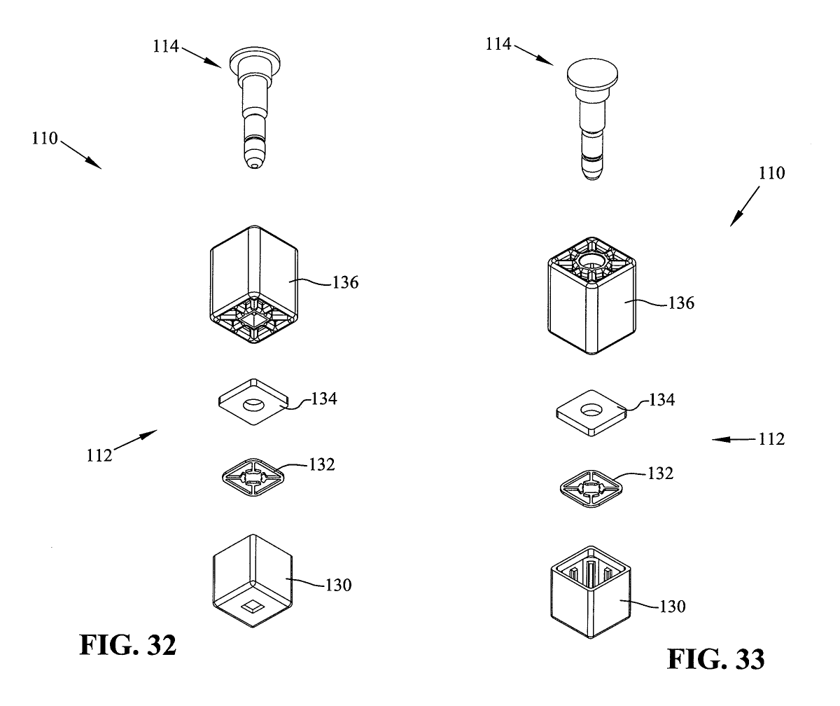

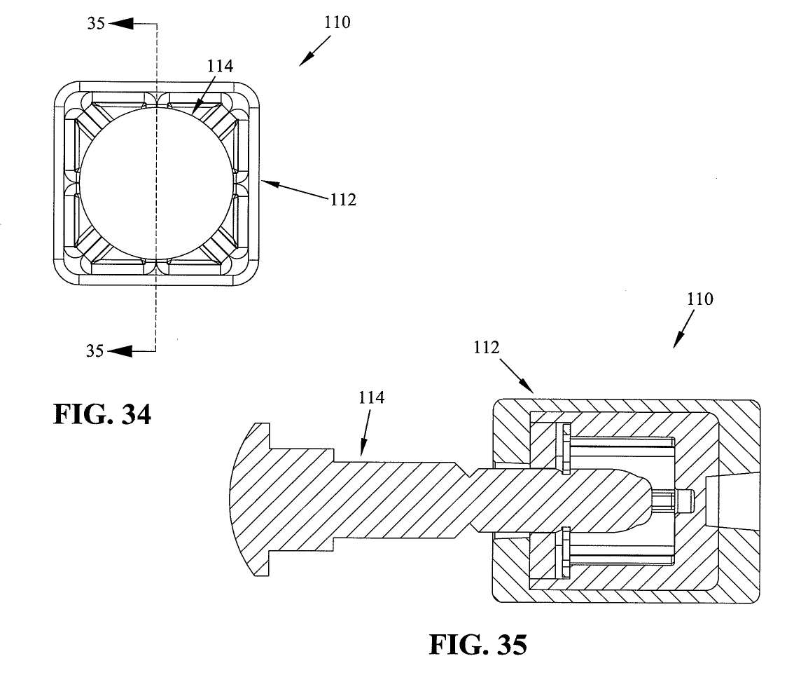

Referring now to FIGS. 31-35, an alternate embodiment of a sealing device in accordance with the subject invention is generally indicated as 110. Sealing device 110 includes a lock body assembly, generally indicated as 112, and a locking bolt, generally indicated as 114. Details of locking bolt 114 are substantially similar to those of bolt 14, except it has a shorter shaft in the embodiment shown.

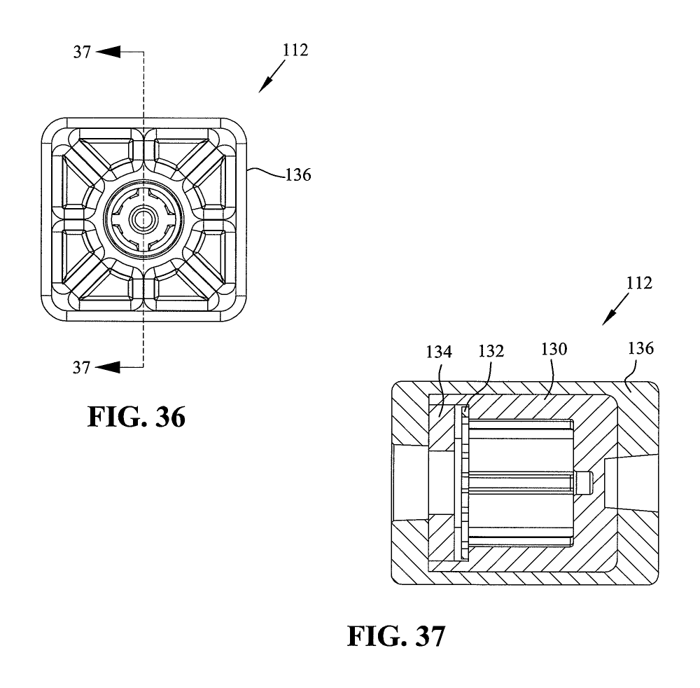

Details of lock body assembly 112 are shown in FIGS. 36-37. Lock body assembly 112 is somewhat similar to lock body assembly 12, except that lock body assembly 112 has a generally rectangular configuration as compared to the generally cylindrical configuration of lock body assembly 12. Lock body assembly 112 includes a lock body 130, a lock clip 132, a washer 134, and an overmold 136.

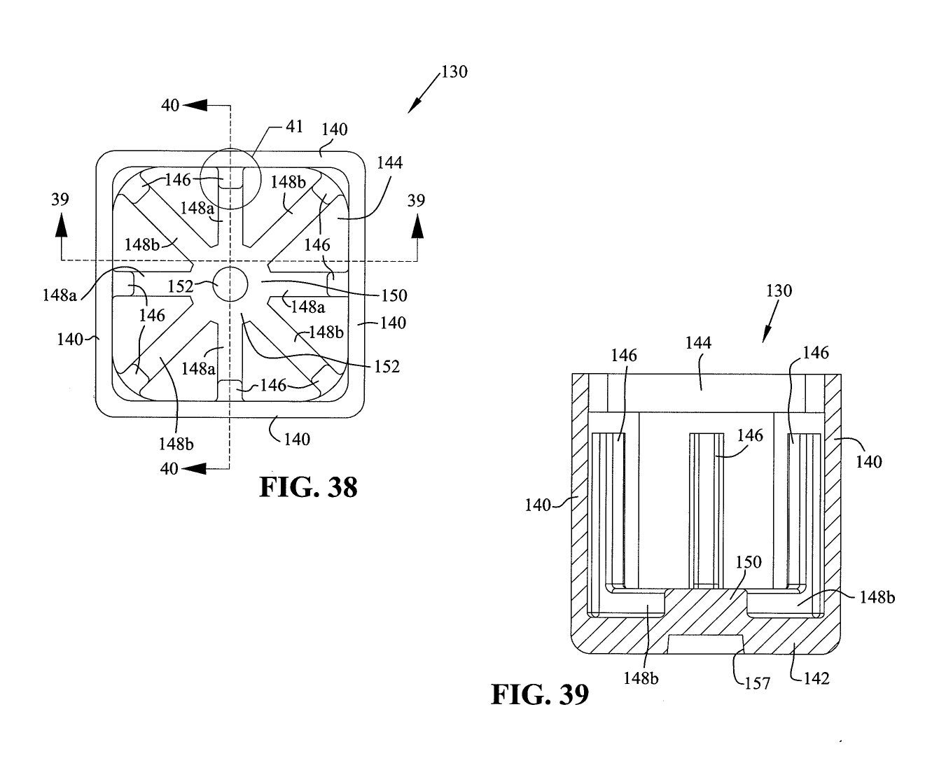

Referring now to FIGS. 38-42, details of lock body 130 are shown. Lock body 130 may be injection molded from an abs plastic or other known suitable materials or methods of manufacture can be used. Lock body 120 has a generally rectangular configuration and includes four side walls 140, a bottom wall 142 at one end of the lock body and an open end 144 at the opposite end. Lock body 130 also includes a plurality of equally spaced axially extending ridges 146. One ridge 146 is located on each side wall 140 in approximately the middle thereof and a ridge 146 is located in each corner wherein side walls 140 intersect, for a total of eight axially extending ridges in the embodiment shown.

In addition, lock body 130 includes a plurality of radially extending equally spaced ridges 148a and 148b on an inner surface of bottom wall 142. One ridge 148a extends to each sidewall 140 and one ridge 148b extends into each corner formed by intersecting side walls 140. Ridges 148a and 148b extend from or intersect a central hub-like ridge 150 on bottom wall 142, and a central opening 152 is located in hub-like ridge 150. In the embodiment shown, there are an equal number of axially extending ridges 146 and radial extending ridges 148a and 148b; however, it should be appreciated that the number of either axially or radial extending ridges can be varied as desired.

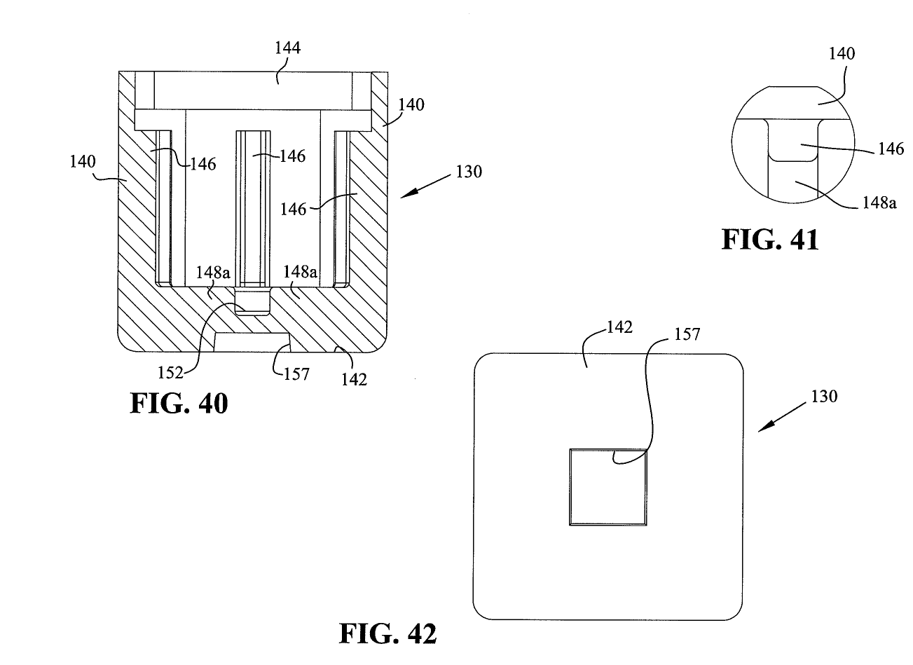

Lock body 130 includes an upper region 154 in side walls 140, wherein axially extending ridges 146 do not extend. In addition, lock body 130 includes a cavity 157 extending into bottom wall 142 as best shown in FIGS. 39 and 40. Cavity 157 has a generally square configuration as best shown in FIG. 42.

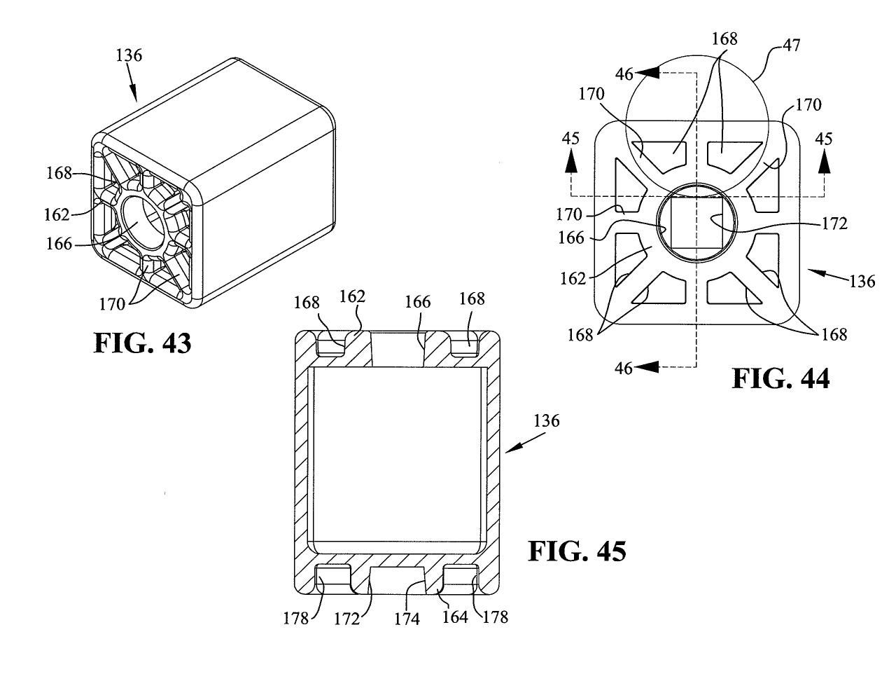

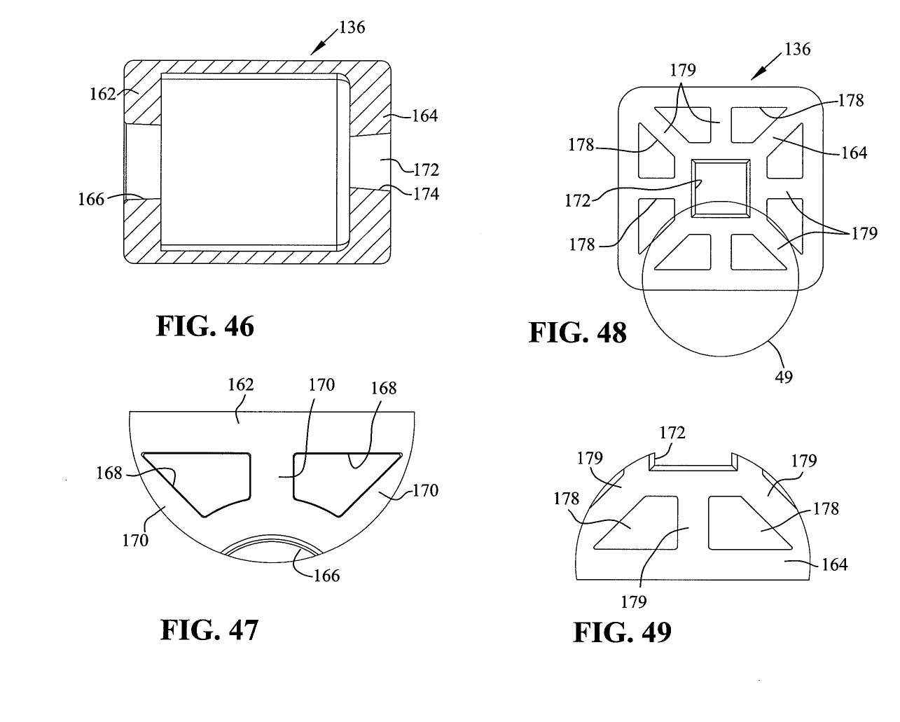

Now referring to FIGS. 43-49, details of overmold 136 are shown. Overmold 136 may be molded from a polypropylene or made using other known suitable materials or methods. Overmold 136 has a generally hollow rectangular configuration and includes four side walls 160, one partially enclosing end wall 162, and another partially enclosing end wall 164. End wall 162 includes a central opening 166, and a plurality of external cavities 168. A plurality of spokes 170 extend between cavities 168. End wall 164 includes a square central opening 172, which may include a taper or chamfer 174. End wall 164 also includes a plurality of external cavities 178 and a plurality of spokes 179 extending between the cavities (see FIGS. 48 and 49).

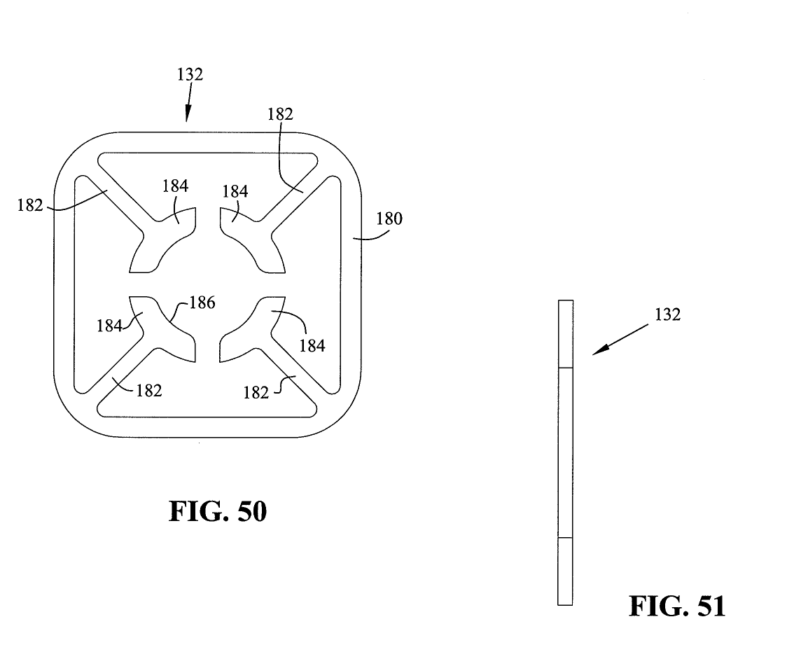

Details of lock clip 132 are shown in FIGS. 50-51. Lock clip 132 can be made from a stamped, high-stenciled banding or manufacture using other known suitable materials or methods. Lock clip 132 includes an outer periphery 180 having a generally square configuration and a plurality of spokes 182 extending inwardly from the corners of periphery 180. Lock clip 132 also includes inner flanges 184 extending generally perpendicular to spokes 182. Flanges 184 form a non-continuous inner ring portion 186.

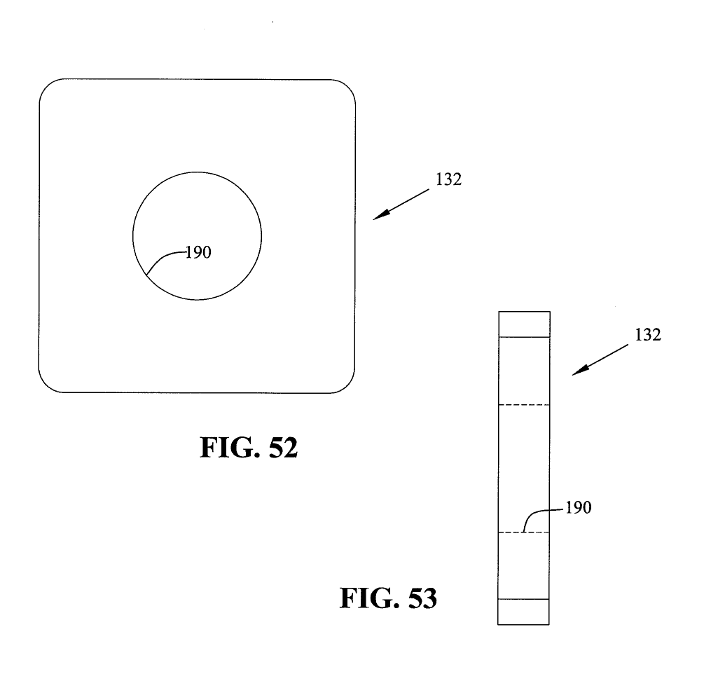

Now referring to FIGS. 52-53, enlarged views of washer 134 are shown. Washer 134 has a generally flat and square configuration and includes a central hole 190. Washer 134 can be stamped from a cold rolled steel or made using other suitable materials or methods.

Lock body assembly 112 is assembled in a similar manner as lock body 12. In operation, sealing device 110 functions similar to sealing device 10 wherein the tapered portion of locking bolt 114 is inserted through opening 166 in the overmold 136 of lock assembly 132. The circumferential groove on locking bolt 114 encounters inner ring portion 186 on lock clip 132, wherein the inner ring portion 186 snaps into the circumferential groove. End 162 of overmold 136 and washer 134 prevent bolt 114 and lock clip 132 from being removed or otherwise pulled out of lock body assembly 112 (FIG. 35). As such, the only way to remove lock bolt 114 is to cut the bolt or destroy lock body assembly 112, thereby providing evidence of tampering.

It should also be appreciated that the rectangular configuration of lock body assembly 112 and generally square cross section help prevent the lock clip 132, washer 134, and lock body 130 from rotating relative to overmold 136. Furthermore, square cavity 157 in lock body 130 and square opening 172 in overmold 136, which is aligned therewith, can be used to orient sealing device 110.

While the invention has been taught with specific reference to these embodiments, one skilled in the art will recognize that changes can be made in form and detail without departing from the spirit and scope of the invention. Therefore, the described embodiments are to be considered, therefore, in all respects only as illustrative and not restrictive. As such, the scope of the invention is indicated by the following claims rather than by the description.

1. A sealing device including:
a bolt having a shaft, a tapered end and a circumferential groove;
a generally rectangular lock body having an open end leading into a hollow portion;
an overmold substantially surrounding said lock body and including an aperture in an end thereof that is aligned with said open end of said lock body;
a lock clip located in said hollow portion of said lock body; and
a washer having a hole aligned with said aperture in said overmold and said open end in said lock body and located between an end of said overmold and said lock clip.

2. The sealing device as set forth in claim 1, wherein said lock clip has a generally square configuration and includes a plurality of spokes extending inwardly from corners of an outer periphery portion.

3. The sealing device as set forth in claim 2, wherein at least some of said spokes include an inner flange extending generally perpendicular to said spokes.

4. The sealing device as set forth in claim 3, wherein said inner flanges form a non-continuous inner ring portion.

5. The sealing device as set forth in claim 1, wherein said overmold has a generally rectangular configuration including a square opening in the end opposite said end with said aperture.

6. The sealing device as set forth in claim 5, wherein said lock body includes a plurality of axially extending ridges projecting from an inner surface in said hollow portion.

7. The sealing device as set forth in claim 6, wherein said lock body includes radially extending ridges on an inner surface of said end opposite said open end.

8. The sealing device as set forth in claim 7, wherein at least some of said axially extending ridges and some of said radially extending ridges intersect.

9. The sealing device as set forth in claim 6, wherein some of said axially extending ridges extend along a central portion of side walls of said lock body and other axially extending ridges extend along corners where said side walls intersect.

10. The sealing device as set forth in claim 7, wherein said lock body includes a central hub-like ridge from which said radially extending ridges project, said hub-like ridge including a central opening.

11. The sealing device as set forth in claim 1, wherein said overmold has a hollow interior and partially closed ends.

12. The sealing device as set forth in claim 11, wherein said end with said aperture includes a plurality of external cavities surrounding said aperture.

13. The sealing device as set forth in claim 12, wherein said other end of said overmold has a tapered square opening aligned with a square cavity in said lock body.

14. The sealing device as set forth in claim 11, wherein said lock clip is located at the top of said axially extending ridges, said washer is located over said lock clip in said lock body, and said washer is located between said end of said overmold having said aperture and said lock clip.

15. A sealing device including:
a bolt having a shaft, a tapered end and a circumferential groove;
a lock body having an open end leading into a hollow portion and an opposite end having a generally square cavity therein;
an overmold substantially surrounding said lock body and including an aperture in one end aligned with said open end of said lock body and a generally square opening in said other end aligned with said cavity in said lock body;
a lock clip located in said bore of said lock body and engaging said circumferential groove in said bolt; and
a washer having a hole aligned with said aperture in said overmold and said open end in said lock body and located between said end of said overmold having said aperture and said lock clip.

16. The sealing device as set forth in claim 15, wherein each of said ends of said overmold include cavities, a central hub, and spokes extending from said central hub between said cavities.

17. The sealing device as set forth in claim 15, wherein said lock body and said overmold have a generally rectangular configuration with a generally square cross section, and said lock clip and said washer have a generally square planar configuration.

18. The sealing device as set forth in claim 15, wherein said lock body includes axially extending ridges along internal surfaces thereof and radially extending ridges on said end having said square cavity.

19. The sealing device as set forth in claim 18, wherein said lock body has side walls forming a generally rectangular configuration and some of said axially extending ridges are located in a central portion of each of said side walls and others of said axially extending ridges are located in corners of said lock body formed by intersecting side walls.

20. A sealing device including:
a bolt having a shaft, a tapered end and a circumferential groove;
a lock body having an open end leading into a hollow portion;
an overmold substantially surrounding said lock body and including an aperture aligned with said open end of said lock body and an opposite end having an opening, each of said ends including cavities surrounding a central hub wherein said respective aperture and opening are located; and
a lock clip located in said hollow portion of said lock body.

21. The sealing device as set forth in claim 20, wherein said lock body and said overmold have generally rectangular configurations, and said lock clip has a generally square planar configuration.

22. A seal device as set forth in claim 21, further including a washer having a hole aligned with said aperture in said overmold and said open end in said lock body.

23. The sealing device as set forth in claim 22, wherein said washer has a generally square planar configuration.
